(19) United States
(12) Patent Application Publication
(10) Pub. No.: US 2012/0188760 A1
(43) Pub. Date: Jul. 26, 2012

(54) SYSTEM, METHOD, AND KIT FOR CREATING ARTWORK UTILIZING DIRECTIONAL LIGHT SOURCE AND CRYSTAL PRISMS

(76) Inventor: Gail R. Mitchell, New York, NY (US)

(21) Appl. No.: 13/010,386

(22) Filed: Jan. 20, 2011

(51) Int. Cl. F21V 9/00; F21V 17/02; F21S 6/00

(52) U.S. Cl. 362/231; 362/257; 362/293; 362/277

(57) ABSTRACT

A system for creating illumination art includes a directional light source unit, prisms, and suspensions/supports for suspending or supporting the prisms between the light source and a surface onto which light from the light source is projected, such that the crystals appear to float in the image projected onto the surface. The light source may be an incandescent or LED source, and the prisms may be Swarovski® Strass® lead crystals. The prisms, suspensions/supports, light source unit, and/or other elements of the system may be provided in kit form.

### BACKGROUND OF THE INVENTION

1. Field of the Invention

This invention relates to a lighting system and method, and to lighting kits, that utilize a directional light source and moving or stationary crystal prisms supported by transparent filaments to create dazzling lighting effects.

2. Description of Related Art

It is well-known to create artwork by manipulating light utilizing LCDs, filters, reflective surfaces, fiber optics, colored light sources, and so forth. An especially notable and ancient example is the stained glass window, in which colored glass is arranged to form patterns or scenes illuminated by ambient light passing through the windows. Also well-known are kaleidoscopes, which use movable crystals illuminated by ambient light to create changeable colored light patterns. In addition, sculptures have been designed to incorporate internal lighting effects, while various art media such as paintings have been combined with lighting arrangements to provide artistic effects unachievable by either lighting or painting alone.

Light paintings or sculptures are known from the following websites:
justluxe.com/mall/limited-edition/classified-231974.php;
Mundyhepburn.com/gallery.html;
rayhowlett.com/gallery.html;
youtube.com/results?search_query=interactive+light+s culpture&aq=0;
lumion.net/home.php
   The artwork displayed or advertised in these websites is not merely decorative, but rather represents a high degree of artistic creativity worthy of display in art galleries along with paintings, sculptures, and more traditional art forms. The present invention provides a variation of the light paintings or sculptures illustrated in the above-listed websites, designed to allow a professional artist to create fine art suitable for display in a gallery, while at the same time also capable of implementation as a kit that allows ordinary consumers to create their own light paintings or sculptures.

The invention uses crystal prisms to create effects similar to those of a kaleidoscope, but in three dimensions rather than two dimensions. While the effects of crystal prisms in separating light into multiple colors is of course well-known, and crystal prisms have long been used in connection with non-directional light sources such as chandeliers (see, e.g., U.S. Patent Publication NO. 2004/0141328), the concept of using directed light to illuminate the crystals, and in particular of using transparent filaments (or other invisible suspension or supporting means) to create the illusion of floating crystals, enables the artist to create truly original works of art that go way beyond the pretty but limited effects provided by the hanging crystals of a conventional chandelier, sun catcher, or other hanging prism.

Further, according to a preferred embodiment of the invention, the crystal prisms may be made of a particular type of crystal having properties that make it especially suitable for use in creating artwork of the type described above. In this embodiment, the material of the prisms is lead crystal glass, in which lead oxide is added to molten glass to give the lead crystal a much higher index of refraction than normal glass, and consequently much greater “sparkle” by increasing specular reflection and the range of angles of total internal reflection. Ordinary glass has a refractive index of n=1.5; the addition of lead produces an index of refraction of up to 1.7. This heightened refractive index also raises the correlating index of dispersion, which measures the degree to which a medium separates light into its component spectra, as in a prism. This increase in refractive index from 1.5 to 1.7 significantly increases the amount of light reflected, by a factor of 1.68 for light reflecting in the normal direction. In addition, in the case of cut glass crystals that have been hand or machine cut with facets, the presence of lead also makes the glass softer and easier to cut. The preferred crystal prisms can include up to 35% lead, at which point they have the most sparkle.

### SUMMARY OF THE INVENTION

It is accordingly an objective of the invention to provide a variation of conventional illumination art that utilizes crystal prisms, directed light, and transparent filaments or strings to create novel and artistic visual effects.

It is a second objective of the invention to provide an art kit that enables consumers to create artwork utilizing crystal prisms, directed light, and transparent filaments or strings.

These objectives are achieved by arranging a directional light source and crystal prisms so that light from the light source is transmitted through the prisms onto a surface, such as a wall or screen, that enables viewing of the transmitted light, and by suspending or supporting the crystal prisms by suspension/support means such as transparent strings or filaments that are invisible to a viewer so that the crystals appear to float in front of the surface.

In a preferred embodiment of the invention, the crystal prisms are made of leaded glass cut into a generally polyhedral shape, such as, by way of example and not limitation, lead octagon crystals. An especially suitable crystal is the Swarovski® Strass® Aurora Borealis 60 mm lead octagon crystal, although cut glass crystal prisms from other sources may also be used. Swarovski® and Strass® are registered trademarks of Swarovski, AG, of Wattens, Austria.

In one implementation of the preferred embodiment, the crystal prisms are illuminated by a cylindrical projection structure with a spotlight or headlight-type incandescent bulb arrangement, or by an LED bulb and projection lenses or reflectors positioned to direct or project light through the crystals.

The crystal prisms may be mounted within the projection structure or suspended between the projection structure and a surface onto which light is projected from the light source through the crystals. In either case, the suspension or support means for the crystal prisms should be invisible, or barely visible, to the viewer so that the crystals appear to float in the image projected onto the surface. Suitable support means include, but are not limited to, transparent filaments (or filaments that are very thin and/or colored to blend into the background).

Especially attractive light effects may be obtained if the crystals are movable, although static arrangement can also yield dramatic results. In implementations where the crystal prisms are suspended by transparent or invisible filaments, movement of the crystal prisms may be effected by natural airflow or by air currents generated with the assistance of a fan, heater, or mechanical device for moving the means by which the crystal prisms are suspended or supported. In addition, implementations of the invention may use combinations of movable and static crystal prisms.

A variety of directed lighting arrangements may be used, including a custom light arrangement and/or a commercially-available LED bulb such the Dragon Fish EES LED Bulb available from TheLEDLight.com, which includes multiple RGB LED bulbs in a housing arranged to fit in an incandescent light socket, and in which color and flashing effects may be controlled by a wireless remote control.

Finally, the invention may further be implemented as an interactive light kit including a plurality of lead crystals or other prism structures, and suspension/support means such as transparent filaments or strings for suspending or supporting the prism structures between a directional light source and a surface on which the light is projected. The light kit may also include the directional light source, means for moving the prism structures or the suspension/support means, and means such as a plurality of color gel filters to provide color effects.

### BRIEF DESCRIPTION OF THE DRAWINGS

FIG. 1 is a schematic illustration of a system for creating interactive light art in accordance with the principles of a preferred embodiment of the invention.

FIG. 2 is a photograph of artwork created using the system of the invention.

FIG. 3 is photograph of a gallery installation of interactive artwork created by the system illustrated in FIG. 1.

FIG. 4 is another view of the gallery installation of FIG. 3.

FIGS. 5A and 5B are respective cross-sectional and top views of a custom lighting unit for use in the system of FIG. 1.

FIG. 6 shows an alternative lighting unit in which crystal prisms are integrated for a static display.

### DETAILED DESCRIPTION OF THE PREFERRED EMBODIMENTS

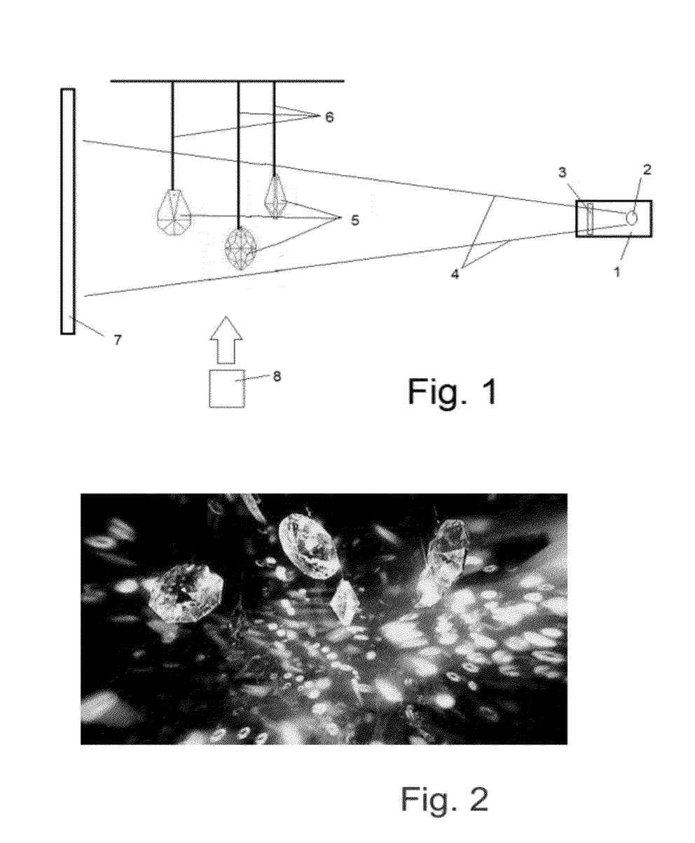

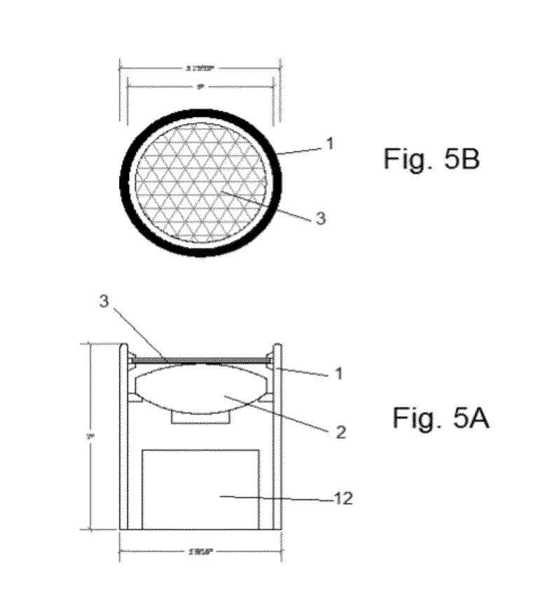

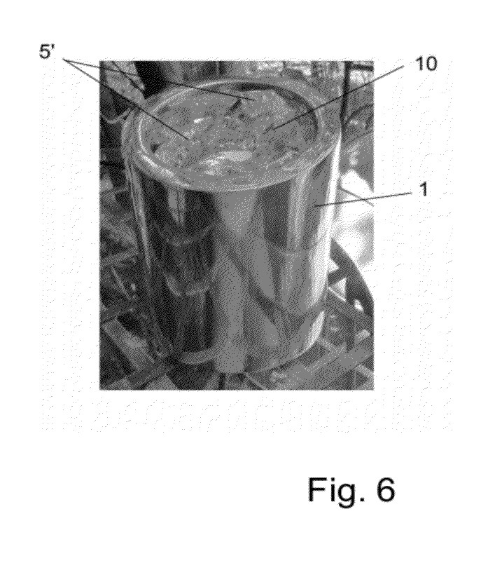

As illustrated in FIG. 1, a preferred embodiment of the invention includes a light source unit made up of a housing 1, at least one light source 2, and an optional lens and/or color filter unit 3. Examples of light source units are shown in FIGS. 5A, 5B, and 6.

The housing 1 may be a cylindrical unit such as is shown in FIGS. 5A and 5B, but a particular housing shape or construction is not essential and shape and construction of the housing may therefore be freely varied without departing from the scope of the invention, so long as it is capable of supporting a light source and of projecting a light beam 4 from the light source through crystal prisms 5 onto a display surface 7. The housing 1 may be fixedly mounted, or may include a pivot or other moving arrangement (not shown), and further may include its own power source or an appropriate transformer, such as transformer 12 shown in FIG. 5A.

The light source 2 may include any directional light source, or multiple light sources, capable of generating the light beam 4 for projection through the prisms 5 onto the surface 7. By way of example, the light source 2 used in the lighting arrangement may be an incandescent bulb such as the GE 4515 bulb, which includes a parabolic reflector to direct the light beam in a preferred direction. Alternatively, the light source 2 may be an incandescent bulb combined with a separate reflector built into the housing 1, or another type of light source such as an LED bulb of the type available from TheLEDLight.com as the Dragon Fish EES LED Bulb, which includes multiple LEDs on an incandescent light bulb base, the LEDs capable of selectively emitting red, green, and blue light in response to commands from a digital controller.

If the light source 2 emits white light, then one or more color filters may be used to achieve colored lighting effects. If the light source 2 is capable of emitting multiple color light, then no further color filter is necessary. The color filters are represented in FIGS. 1, 5A, and 5B by unit 3, which may optionally also include, or be replaced by, lenses or other optical elements such as gratings, slides, holographic films, and so forth, to expand the variety of lighting effects. In addition, multiple light source units, with separate housings, may be arranged to illuminate the crystals from different directions, either simultaneously or at different times to achieve still further lighting effects.

The crystal prisms 5 through which the light beam 4 is projected may be fixedly or movably positioned by any suitable suspension or support means, including by way of example and not limitation, transparent strings or filaments 6 for suspending the prisms from a ceiling or track, the suspension/support means being invisible to a viewer so as to cause the crystals appear to float within the image projected on surface 7. If strings or filaments are used, then the prisms may be movable by air currents, either natural or forced through the use of an appropriately positioned heater or fan 8. Alternatively, the crystals may be suspended from or supported by a movable structure such as a rotating disc or the like (not shown), or disposed in a liquid medium (also not shown), in order to create a more dynamic motion effect, and/or combinations of moving and statically-supported crystal prisms may be used.

The crystal prisms 5 themselves are preferably made of cut lead crystal, although other transparent or translucent materials may be used, including other types of glass and various plastic materials that can be cut or shaped to have refractive properties and thereby disperse light passing through the crystals in visually interesting ways. An especially preferred type of crystal prism is the Swarovski® Strass® Aurora Borealis 60 mm lead octagon crystal, although those skilled in the art will appreciate that the invention is not limited to a particular size of crystal (dimensions other than 60 mm may be used) or shape (any polyhedral shape, whether regular or not, may be used, depending on the desired artistic effect).

Finally, the surface 7 may be any surface on which light beam 4 can be projected, including the wall of a gallery or a solid or translucent screen. The surface may be viewed from either side, depending on whether it is solid or translucent, and may be fixed or movable, solid colored and/or with additional painted, printed, or sculpted design elements.

In a preferred implementation of the system of FIG. 1, the various elements of the system are provided in kit form. The kit preferably includes a plurality of the crystals 5 and filaments 6 or other elements for suspending or supporting the crystals. The kit may also include a light source unit having, for example, housing 1 and light source 2, as well as an optical unit 3 with color filters and/or other optical elements, although it is also possible for the crystals and filaments in the kit to be used with a separately provided or existing directional light source. The crystal and filaments, and/or other elements of the kit, are packaged with instructions on how to arrange the elements to create art of the type shown in FIG. 2. As a result, the kit provides all of the elements necessary for an ordinary consumer to create illumination art of the type described above.

The invention also provides a method of creating illumination art, the method including the steps of positioning a light source and positioning a plurality of crystal prisms between the light source and a surface such that light from the light source is projected onto the surface through the plurality of crystal prisms. As described above, the light source may be an incandescent or LED source, and the prisms may be Swarovski® Strass® lead crystals.

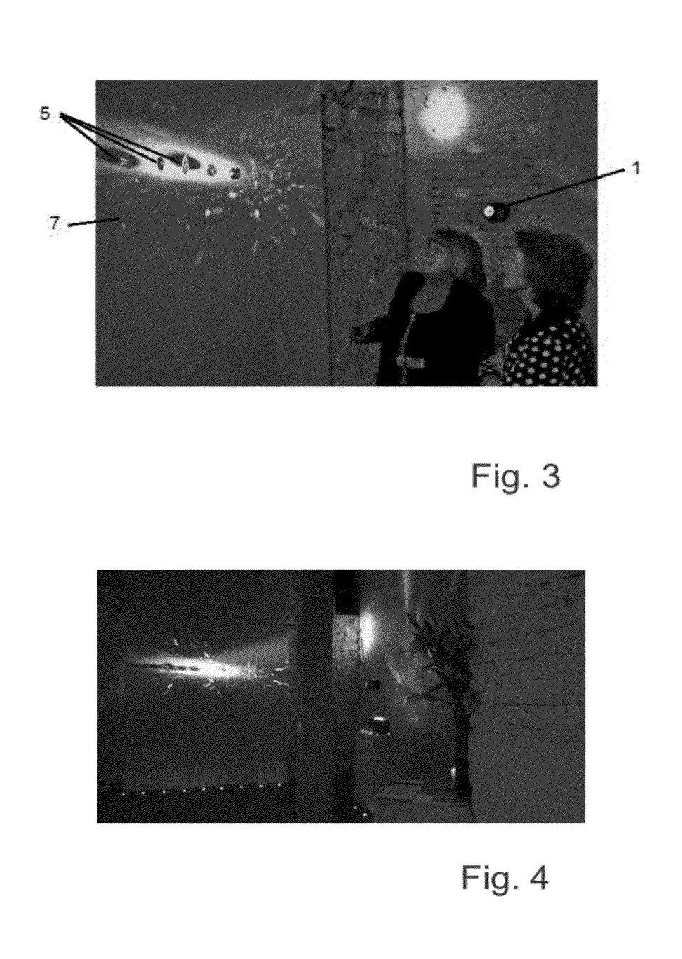

FIG. 2 shows one example of the visually stunning effects that can be obtained by the system illustrated in FIG. 1. The nature of the effects is limited only by the imagination or vision of the artist creating the effects. In the case of a gallery installation, such as the one shown in FIGS. 3 and 4, multiple surfaces can be used to immerse the viewer in the art work, and the user can even be enabled to participate in the art by controlling colors, movement of the crystal prisms 5, and so forth.

FIG. 6 shows an alternative light unit that also includes a cylindrical housing 1, but that also houses the crystal prisms 5′. For example, the crystal prisms may be placed in a transparent container 10, which may hold the crystals loosely or encapsulate them, to create a static display upon projection of light through the crystals. As with the system of FIG. 1, the light unit/crystal prism combination of FIG. 6 may be in the form of a kit that can be assembled by a purchaser of the kit.

Having thus described a preferred embodiment of the invention and variations of the preferred embodiment in sufficient detail to enable those skilled in the art to make and use the invention, it will nevertheless be appreciated that numerous variations and modifications of the illustrated embodiment may be made without departing from the spirit of the invention. Accordingly, it is intended that the invention not be limited by the above description or accompanying drawings, but that it be defined solely in accordance with the appended claims.

I claim:

1. An interactive light system, comprising:
a directional light source unit;
a plurality of crystal prisms;
suspension/support means for suspending or supporting the crystal prisms between the light source and the projection surface such that the light beams emitted by the light source pass through the crystal prisms to a projection surface to create artwork, said suspension/support means being invisible to a viewer such that the crystals appear to float in front of the surface.

2. An interactive light system as claimed in claim 1, wherein the light source unit includes a housing and at least one light source.

3. An interactive light system as claimed in claim 2, wherein the housing is a cylindrical housing.

4. An interactive light system as claimed in claim 1, wherein the light source is an incandescent bulb, and further comprising at least one color filter positioned in front of the light source to change a color of light emitted by the light source.

5. An interactive light system as claimed in claim 1, wherein the light source is an LED.

6. An interactive light system as claimed in claim 5, wherein the light source include multi-colored LEDs and a controller for causing light emitted by the light source to change colors.

7. An interactive light system as claimed in claim 1, wherein the crystal prisms are leaded glass crystal prisms.

8. An interactive light system as claimed in claim 7, wherein the crystal prisms are Swarovski® Strass® lead crystal prisms.

9. An interactive light system as claimed in claim 1, wherein the suspension/support means are transparent filaments.

10. An interactive light system as claimed in claim 1, wherein the crystal prisms and suspension/support means are provided as a kit.

11. An interactive light system as claimed in claim 10, wherein the kit further includes the light source unit.

12. An interactive light system as claimed in claim 10, wherein the crystal prisms are Swarovski® Strass® lead crystal prisms.

13. An interactive light system as claimed in claim 10, wherein the suspension/support means are transparent filaments.

14. An interactive light system as claimed in claim 1, further comprising moving means for causing said crystal prisms to move.

15. An interactive light system as claimed in claim 1, wherein said moving means includes a fan.

16. An interactive light system as claimed in claim 1, wherein said suspension/support means fixedly supports said crystal prisms within a housing of the light source.

17. A method of creating interactive artwork, comprising the steps of:
positioning a light source; and
suspending or supporting crystal prisms between the light source and the projection surface such that the light beams emitted by the light source pass through the crystal prisms onto a projection surface so as to create artwork, and such that suspensions or supports for the crystals are substantially invisible to a viewer; and
causing light beams from said light source to be transmitted through said crystal prisms to said projection surface.

18. A method as claimed in claim 17, wherein the crystal prisms are Swarovski® Strass® lead crystal prisms.

19. A method as claimed in claim 17, wherein the crystals are suspended by transparent filaments.
